(19) United States
(12) Patent Application Publication
(10) Pub. No.: US 2006/0116799 A1
(43) Pub. Date: Jun. 1, 2006

(54) Method for monitoring chassis functions and chassis components

(75) Inventor: Rudiger Mahlo, Berlin (DE)

Correspondence Address: Gerlinde M Nattler;Continental Teves Inc, One Continental Drive, Auburn Hills, MI, 48326, US

(73) Assignee: Continental Teves AG & Co. oHG, Frankfurt (DE)

(21) Appl. No.: 10/525,493

(22) PCT Filed: Aug. 22, 2003
(86) PCT No.: PCT/EP03/09321

§ 371 Date: Oct. 17, 2005

(30) Foreign Application Priority Data
Aug. 27, 2002 (DE) 102 39 987.5

(51) Int. Cl. G06F 19/00

(52) U.S. Cl. 701/29; 340/438

(57) ABSTRACT

To monitor chassis functions and chassis components of a motor vehicle and/or to detect wear, wear trends, component defects or declining functions, information provided by control systems mounted in the vehicle and/or obtained by way of additional sensors is evaluated. Evaluations relating to vehicle dynamics are carried out on the basis of said information, with reproducible vehicle or driving conditions, and taken into account in order to statistically evaluate specific features, which directly or indirectly reflect chassis functions and/or the condition of chassis components, and to subsequently identify defects or malfunctions.

### BACKGROUND OF THE INVENTION

The present invention relates to a method for monitoring chassis functions and chassis components of a motor vehicle and/or for detecting wear, wear trends, component defects or declining functions.

The tendency prevailing in the automotive industry of extending the inspection intervals for a vehicle in order to achieve a customer-friendly minimization of the current costs by way of the lifetime of products sets exacting standards as regards the fatigue strength of the components employed.

In what intervals servicing takes place generally orients itself by the mileage or the service life of a vehicle. Modern solutions offer an extension of the usual intervals within the limits of ‘long life warranties’ by way of a computer-aided evaluation of the vehicle stress. Primarily the engine load is taken into account for evaluating the vehicle stress.

The stress of the chassis components over such extended intervals cannot be detected and taken into account by using the previously known methods. As the stress to which the chassis components are exposed significantly depends on the driving style of the vehicle operator, greater likelihood of wear and malfunction will be encountered over longer distances with a particularly agile driving style compared to a ‘normal operation’. In this respect, wear trends or defects occurring as a result of longer inspection intervals with an exposure to average stress or as a result of qualitative deficiencies may cause damages, which can incur high costs for the end user and for the parts supplier (original equipment manufacturer of motor vehicles) having to satisfy claims for reasons of obligingness. Therefore, there is a high demand for an early detection of wear and defects and inspection aids for monitoring chassis components.

In view of the above, an object of the invention involves overcoming the described shortcomings of conventional monitoring methods and developing a method that allows monitoring chassis functions and chassis components by entailing relatively little effort.

### SUMMARY OF THE INVENTION

It has shown that this object can be achieved by—a method including

that information provided by control systems mounted in the vehicle and/or obtained by way of additional sensors is evaluated, that evaluations relating to vehicle dynamics are carried out on the basis of said information, with reproducible vehicle or driving conditions, and that the evaluations relating to driving dynamics are taken into account in order to statistically evaluate specific features, which directly or indirectly reflect chassis functions and/or the condition of chassis components, and to subsequently identify defects or malfunctions.

Thus, the invention is based on the reflection that evaluating the information available due to the variety of sensors in up-to-date vehicles equipped with electronic control systems such as ABS, TCS, ESP, etc. renders it possible to develop a driving-dynamics-related evaluation algorithm for solving the problems described hereinabove.

It is an important advantage that for realizing the method of the invention it is necessary to increase the manufacturing effort not at all or only minimally. The safety of the motor vehicle is significantly enhanced due to the (long-term) monitoring provisions the invention offers. In addition, inspections can now be carried out purposefully.

According to a favorable embodiment of the invention, for detecting the vehicle or driving conditions and for carrying out the driving-dynamics evaluations, the following signals sent by the sensors of an electronic brake system such as ABS, TCS, ESP, etc. mounted in the vehicle, are utilized exclusively or in conjunction with the signals of additional sensors, in particular of sensors of chassis-related control systems:
wheel speed information,
lateral acceleration,
yaw rate and
system pressure.

The vehicle deceleration and/or the suspension travels can be determined and evaluated in addition.

Another embodiment of the method of the invention involves that one or more of the following reproducible specific vehicle or driving conditions
straight travel
cornering
stable vehicle
unstable vehicle
freely rolling vehicle
decelerated vehicle
accelerated vehicle

can be detected and evaluated by a detection of patterns on the basis of the information supplied by the control systems provided in the vehicle and/or obtained by means of additional sensors.

The detected specific vehicle or driving conditions and/or anomalies induced by a defect and typical of a situation are taken into account when assessing and evaluating the information. Suitably, the evaluation of the detected vehicle or driving conditions and/or the anomalies induced by a defect and typical of a situation takes place only when the vehicle or driving conditions satisfy predetermined qualitative and quantitative marginal conditions or reach predefined limit values.

Further features, advantages, and possible applications can be taken from the following description of details of the invention and the attached drawings.

### BRIEF DESCRIPTION OF THE DRAWINGS

In the drawings,

FIG. 1A, FIG. 1B and FIG. 1C depict an embodiment of the method of the invention in the way of a functional diagram or flow chart.

### DETAILED DESCRIPTION OF THE DRAWINGS

To assess the wear condition of the chassis or individual chassis functions of a vehicle, it is necessary to define relevant periods of observation of the vehicle or driving condition by way of a constellation of signals and to quantitatively evaluate the constellations of signals within these periods. The results can be stored in a learning algorithm corresponding to the situation and, when looked at over long periods of time or intervals, can be compared with each other in similar situations and with similar constellations of signals in order to identify effects from which component defects (e.g. shock absorber, bearing, drive, suspension) can be inferred. Trends or wear effects detected can be stored in an error memory (already provided or additional) of the existing vehicle control system and tested in detail during the next inspection. This allows improving an early detection of imminent defects. Serious, unambiguously detectable defects are instantaneously indicated to the driver by means of a (chassis) warning lamp.

Signal Conditioning:

E.g. the signals of the following sensors can be used for detecting the driving condition of the vehicle or as utilizable information:
wheel speed sensors,
lateral acceleration sensor,
yaw rate sensor,
steering angle sensor,
pressure sensors of the brake system and
possibly existing additional sensors (e.g. suspension travel sensors, deceleration sensors).

Modern vehicles equipped with ESP are anyway provided with extensive information. When the vehicle is correspondingly configured with additional sensors, the quality of the algorithm can still be improved by taking into consideration further information.

Situation Detection:

When looking at the above-mentioned sensor signals as a whole, combination and pattern detection allow unambiguously detecting some different vehicle or driving situations and defining them with respect to each other.

To evaluate the vehicle stress and observe arising defects, for example, the following, definable situations are considered as relevant:
straight travel
cornering
stable vehicle
unstable vehicle
freely rolling vehicle
accelerated/decelerated vehicle.

Situation Evaluation:

When a situation mode is undoubtedly identified, it can be quantified in its configuration by way of typical situation features. This quantification can be considered an indicator of the loading of the vehicle. For evaluating the system ‘vehicle’, it is possible to define features critical for defined marginal conditions in these situations, said features indicating component defects.

For the technical realization, it is principally needed to check the possibilities of assigning specific marginal conditions and features typical of defects to each other by way of a determined combination of signals and a detection of patterns in order to detect component defects unambiguously.

The configuration of the signals can vary in dependence on the vehicle configuration. E.g. the tendency of a declining limit speed during cornering with equal marginal conditions (or lateral acceleration, steering angle, etc.) can be an indicator of a declining operativeness of the chassis components due to general wear.

For example, defective shock absorbers or a wrong tire pressure on the outside of a bend are the cause of oscillating signals of yaw rate and lateral acceleration in stable cornering maneuvers. If similar resonance effects or configurations of features confirm this assumption also in other driving situations, the suspicious factors will accumulate and can be purposefully specified when there is additional information (e.g. by means of tire pressure detection methods such as DDS, TPMS). When similar effects increase in frequency and intensity and lead to suspicious factors beyond a fixed perception threshold, registration will take place by means of the signal of a warning lamp or by storage in the inspection memory of the vehicle, thus providing support when the vehicle is serviced in the workshop. The suspicious factors or the learnt value will be reset again by deleting the memory after inspection has been carried out. The statistical long-term observation for formulating the suspicious factors can be realized by a corresponding learning algorithm within the program structure of the existing electronic brake system (EBS).

Among others, the following features and combinations of features of the invention are important:

To evaluate the chassis function of a vehicle with a view to detecting wear trends and component defects, existing sensors are used to carry out driving-dynamics-related observations under reproducible vehicle conditions that allow statistically evaluating specific features.

To detect the driving situations, exclusively the following signal information furnished by an electronic brake system (EBS) is utilized according to a first embodiment of the method of the invention:
a. wheel speed,
b. lateral acceleration
c. yaw rate, and
d. system pressure.

In a second embodiment, the vehicle deceleration and/or the suspension travel are additionally taken into account for the qualitative improvement of the method, and this information can be found by means of corresponding sensors being, as is a frequent occurrence, required anyway for the control.

It has been proven favorable in another embodiment of the invention to find out by way of corresponding signal information and/or detection of patterns which of the following driving conditions prevail at the moment:
a. straight travel
b. cornering
c. stable vehicle
d. unstable vehicle
e. freely rolling vehicle
f. decelerated vehicle
g. accelerated vehicle.

A distinction of this type has proven suitable in the signal evaluation.

Further, signal features have been specified for the detection of wear tendencies and component details, allowing the identification of an anomaly induced by a defect and typical of a situation under the above-mentioned specific driving conditions.

A consideration and evaluation of the signal features takes place only when the driving conditions described hereinabove satisfy determined qualitative and quantitative marginal conditions.

The anomalies perceived are accumulated related to features within a statistical program algorithm and considered as a whole in order to formulate a condition diagnosis for individual components or groups of components. When the signals in the accumulated feature anomalies described exceed a defined perception threshold, a diagnosis report is issued, i.e. by switching on a warning lamp, or an error is input in the memory.

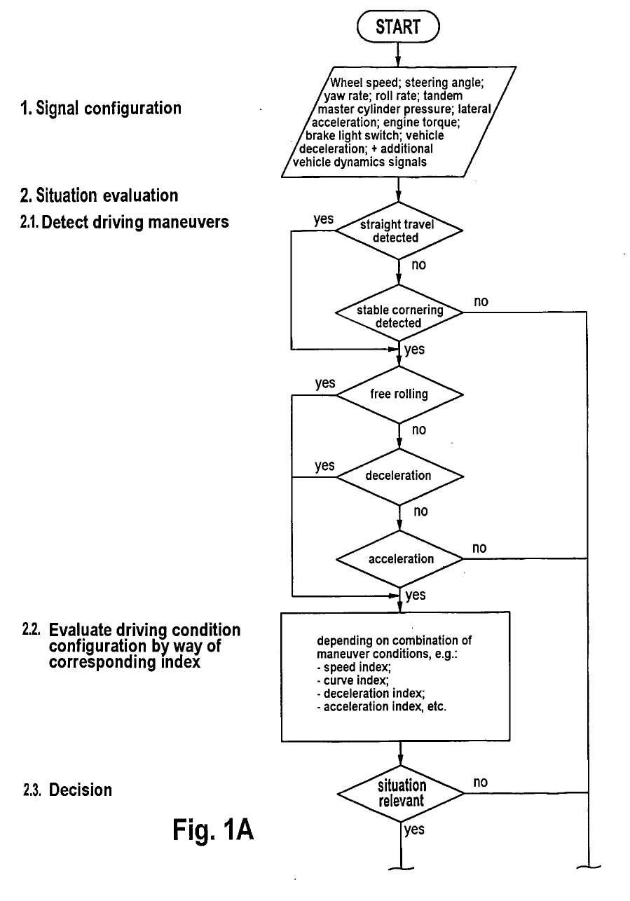

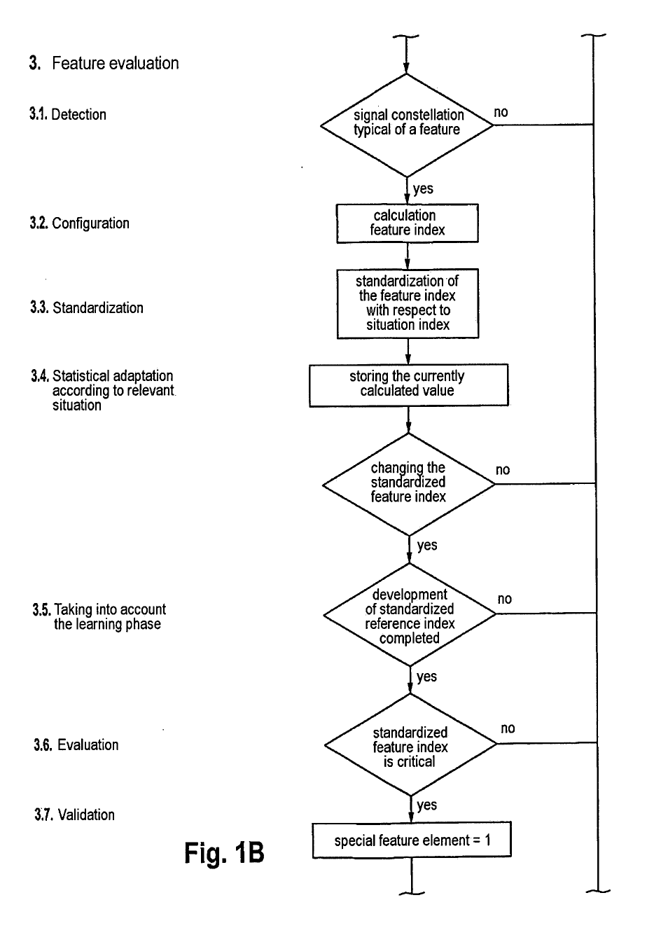

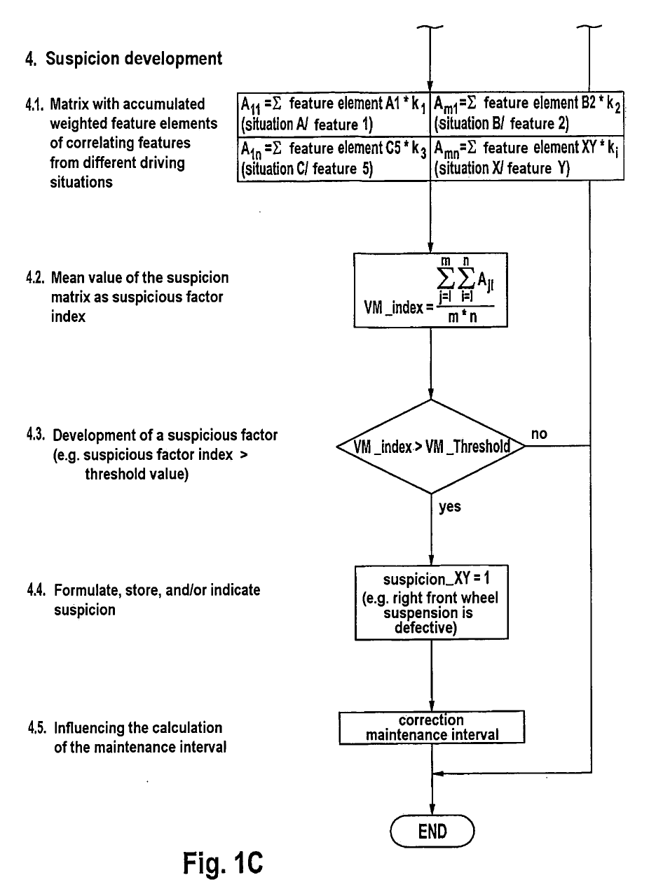

The enclosed illustration (FIG. 1A, FIG. 1B, FIG. 1C) showing a functional diagram or a flow chart serves for depicting essential features and steps of an embodiment of the method of the invention. The individual ‘stations’ in the course of procedure are referred to and characterized in FIG. 1A, FIG. 1B, FIG. 1C as follows:

FIG. 1A:
1. ‘Signal Configuration’: The information required or available is compiled and evaluated in the form of defined signals. The diagram exhibits the signals such as wheel speed, steering angle, etc., being evaluated herein as relevant and taken into account for implementing the monitoring method of the invention.
2. The ‘situation evaluation’ comprises the following individual steps or individual provisions:
2.1 ‘Driving maneuver detection’ such as ‘straight travel’ or ‘stable cornering’, etc.;
2.2 Evaluation of the ‘driving condition configuration’ by means of dimension figures or indices;
2.3 ‘Decision’ about the relevance of the instantaneous driving situation.

FIG. 1B:
3. ‘Feature evaluation’:
3.1 ‘Detection’ of a constellation or combination of signals typical of a feature;
3.2 ‘Configuration’ Calculation of a measured value or an index;
3.3 ‘Standardization’ of the measured value;
3.4 ‘Statistical evaluation’ of the specific features and storage of the current value;
3.5 ‘Learning phase’;
3.6 ‘Evaluation’ of the learning progress;
3.7 ‘Validation’ of the current values.

FIG. 1C:
4. ‘Suspicion development’: Numerical evaluation of the information acquired;
4.1 Producing a ‘suspicion matrix’ from the accumulated, weighted feature elements of correlating features originating from different vehicle or driving situations;
4.2 Producing a mean value on the basis of the ‘suspicion matrix’ for determining a suspicious factor index as an indicator of the relevance of the current suspicion;
4.3 Producing and evaluating the current ‘suspicious factor’;
4.4 Formulate, store and/or display the ‘suspicion’; issue a warning signal, if necessary;
4.5 Correction of the previously valid ‘maintenance interval’.

Thus, a method of the type described hereinabove permits achieving an early detection of chassis defects, faulty operation and other defects alone by evaluation of the information available, without any appreciable increase in the effort of manufacture. This is a precondition for an early, low-cost repair and reduces the risk of damages due to stealthy and therefore scarcely noticeable wear. Driving safety is significantly enhanced.

1-8. (canceled)

9. A method for monitoring chassis functions and chassis components of a motor vehicle, including the steps of
evaluating information provided by at least one of the elements of the group,
consisting of control systems mounted in the vehicle and additional sensors,
performing evaluations relating to vehicle dynamics on the basis of said information with reproducible conditions, and
taking into account the evaluations relating to driving dynamics in order to statistically evaluate specific features which reflect chassis-related conditions, and
to subsequently identify defects.

10. The method as claimed in claim 9,
wherein for detecting the vehicle or driving conditions and for carrying out evaluations, the following signals sent by sensors of an electronic brake system provided in the vehicle, are utilized:
wheel speed information,
transverse acceleration,
yaw rate, and
system pressure.

11. The method as claimed in claim 9,
wherein additionally at least one of the following quantities are determined and evaluated:
vehicle deceleration and
suspension travel.

12. The method as claimed in claim 9,
wherein at least one of the following reproducible specific conditions are detected and evaluated by a detection of patterns on the basis of the information supplied:
straight travel
cornering
stable vehicle
unstable vehicle
freely rolling vehicle
decelerated vehicle
accelerated vehicle

13. The method as claimed in claim 12,
wherein the detected specific conditions and anomalies induced by a defect and typical of a situation are taken into account when assessing and evaluating the obtained information.

14. The method as claimed in claim 13,
wherein the evaluation of the detected conditions and the anomalies induced by a defect and typical of a situation takes place only when the conditions satisfy predetermined qualitative and quantitative conditions.

15. The method as claimed in claim 13,
wherein the detected anomalies are accumulated related to features within a statistical program algorithm and considered and evaluated as a whole.

16. The method as claimed in claim 15,
wherein at least one of the two following actions are performed as soon as the anomalies are detected:
issuing a warning signal
making an error input in a memory.

17. The method as claimed in claim 15,
wherein at least one of the two following actions are performed as soon as the anomalies have exceeded a defined perception threshold:
issuing a warning signal
making an error input in a memory.
